(19) United States
(12) Patent Application Publication
(10) Pub. No.: US 2014/0266016 A1
(43) Pub. Date: Sep. 18, 2014

(54) Charging Circuit and Charger

(71) Applicant: Huawei Device Co., Ltd., Shenzhen (CN)

(72) Inventors: Hualin Li, Shanghai (CN); Linfang Jin, Shenzhen (CN); Liechun Zhou, Shenzhen (CN)

(73) Assignee: Huawei Device Co., Ltd., Shenzhen (CN)

(21) Appl. No.: 14/291,530

(22) Filed: May 30, 2014

Related U.S. Application Data
(63) Continuation of application No. PCT/CN2013/070091, filed on Jan. 6, 2013.

(30) Foreign Application Priority Data
Jan. 16, 2012 (CN) 201210013672.7

(51) Int. Cl. H02J 7/00

(52) U.S. Cl. CPC H02J 7/0029; H02J 7/0052; H02J 7/007
USPC 320/107; 320/150

(57) ABSTRACT

A charging circuit and a charger are provided. The charging circuit includes a temperature detection unit, a charging unit, and a control unit. In the present invention, the charging circuit adjusts a magnitude of a charging current according to a temperature of a product being charged or the charger and then controls the temperature of the product being charged or the charger, thereby greatly improving user experience, and enhancing safety performance of the product with a heat protection function.

### CROSS-REFERENCE TO RELATED APPLICATIONS

This application is a continuation of International Application No. PCT/CN2013/070091, filed on Jan. 6, 2013, which claims priority to Chinese Patent Application No. 201210013672.7, filed on Jan. 16, 2012, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of charging circuits, and in particular, to a charging circuit and a charger.

### BACKGROUND

Nowadays, with widespread use of electronic terminals, chargers for charging the electronic terminals are also widely used. In general, an existing charger provides overvoltage protection or over-current protection during charging.

However, when a user charges the electronic terminal such as a mobile phone, a product being charged or the charger may generate considerable heat because of an excessively high charging current. This affects user experience and the heat may even lead to a thermal safety accident.

### SUMMARY

An objective of embodiments of the present invention is to provide a charging circuit to resolve a problem that a thermal safety accident may be caused by considerable heat generated by a product being charged or a charger because of an excessively high charging current during charging.

An embodiment of the present invention is implemented as follows: a charging circuit, where the charging circuit includes a temperature detection unit configured to detect a temperature of a product being charged or a charger and generate temperature detection information; a charging unit disposed between a charging power supply and the product being charged, and configured to provide a charging current for the product being charged; and a control unit separately connected to the temperature detection unit and the charging unit, and configured to separately compare the temperature detection information with a preset temperature upper limit and a preset temperature lower limit, control the charging unit so as to reduce the charging current when the temperature of the product being charged or the charger reaches the temperature upper limit, and control the charging unit so as to increase the charging current when the temperature of the product being charged or the charger reaches the temperature lower limit.

Another objective of the embodiments of the present invention is to provide a charger, where the charger includes a charging circuit, and the charging circuit includes: a temperature detection unit configured to detect a temperature of a product being charged or the charger and generate temperature detection information; a charging unit disposed between a charging power supply and the product being charged, and configured to provide a charging current for the product being charged; and a control unit separately connected to the temperature detection unit and the charging unit, and configured to separately compare the temperature detection information with a preset temperature upper limit and a preset temperature lower limit, control the charging unit so as to reduce the charging current when the temperature of the product being charged or the charger reaches the temperature upper limit, and control the charging unit so as to increase the charging current when the temperature of the product being charged or the charger reaches the temperature lower limit.

In the embodiments of the present invention, a charging circuit adjusts a magnitude of a charging current according to a temperature of a product being charged or a charger, and then controls the temperature of the product being charged or the charger, thereby greatly improving user experience, and enhancing safety performance of the product with a heat protection function.

### BRIEF DESCRIPTION OF THE DRAWINGS

FIG. 1 is a module structural diagram of a charging circuit according to an embodiment of the present invention; and

FIG. 2 is a circuit structural diagram of a charging circuit according to an embodiment of the present invention.

### DETAILED DESCRIPTION

To make the objectives, technical solutions, and advantages of the present invention clearer and more comprehensible, the following further describes the present invention in detail with reference to the accompanying drawings and embodiments. It should be understood that the specific embodiments described herein are merely used to explain the present invention but are not intended to limit the present invention.

FIG. 1 illustrates a module structure of a charging circuit according to an embodiment of the present invention. For ease of description, only a part related to this embodiment of the present invention is illustrated.

The charging circuit includes: a temperature detection unit 100 configured to detect a temperature of a product 500 being charged or a charger and generate temperature detection information; a charging unit 300 disposed between a charging power supply 400 and the product 500 being charged, and configured to provide a charging current for the product 500 being charged; and a control unit 200 separately connected to the temperature detection unit 100 and the charging unit 300, and configured to separately compare the temperature detection information with a preset temperature upper limit and a preset temperature lower limit, control the charging unit 300 so as to reduce the charging current when the temperature of the product 500 being charged or the charger reaches the temperature upper limit, and control the charging unit 300 so as to increase the charging current when the temperature of the product 500 being charged or the charger reaches the temperature lower limit.

FIG. 2 illustrates a circuit structure of the charging circuit according to the embodiments of the present invention. For ease of description, only a part related to the embodiments of the present invention is illustrated.

In one embodiment of the present invention, the temperature detection unit 100 includes: a thermistor R1 and a voltage divider resistor R2, where a first terminal of the voltage divider resistor R2 connects to a power supply 600, a second terminal of the voltage divider resistor R2 is grounded by using the thermistor R1, and a common connection terminal between the voltage divider resistor R2 and the thermistor R1 connects to the control unit 200.

The power supply 600 is a power supply terminal of a board power manager (PMU) or a charger.

In one embodiment of the present invention, the control unit 200 includes a main processing chip U1, where a detection terminal ADC of the main processing chip U1 connects to the common connection terminal between the voltage divider resistor R2 and the thermistor R1, and an output terminal OUT of the main processing chip U1 connects to the charging unit 300.

In one embodiment of the present invention, the charging unit 300 includes a charging chip U2, where an input terminal IN of the charging chip U2 connects to the charging power supply 400, a control terminal Ctrl of the charging chip U2 connects to the output terminal OUT of the main processing chip U1, and an output terminal OUT of the charging chip U2 connects to the product 500 being charged.

In one embodiment of the present invention, the thermistor R1 is located on a board in a superheated area of the charger's housing or a board in a superheated area of a housing of the product 500 being charged.

An embodiment of the present invention further provides a charger, where the charger includes a charging circuit. As shown in FIG. 1, the charging circuit includes: a temperature detection unit 100 configured to detect a temperature of a product 500 being charged or the charger and generate temperature detection information; a charging unit 300 disposed between a charging power supply 400 and the product 500 being charged, and configured to provide a charging current for the product 500 being charged; and a control unit 200 separately connected to the temperature detection unit 100 and the charging unit 300, and configured to separately compare the temperature detection information with a preset temperature upper limit and a preset temperature lower limit, control the charging unit 300 so as to reduce the charging current when the temperature of the product 500 being charged or the charger reaches the temperature upper limit, and control the charging unit 300 so as to increase the charging current when the temperature of the product 500 being charged or the charger reaches the temperature lower limit.

As shown in FIG. 2, in one embodiment of the present invention, the temperature detection unit 100 includes: a thermistor R1 and a voltage divider resistor R2, where a first terminal of the voltage divider resistor R2 connects to a power supply 600, a second terminal of the voltage divider resistor R2 is grounded by using the thermistor R1, and a common connection terminal between the voltage divider resistor R2 and the thermistor R1 connects to the control unit 200.

The power supply 600 is a power supply terminal of a PMU or the charger.

In one embodiment of the present invention, the control unit 200 includes a main processing chip U1, where a detection terminal ADC of the main processing chip U1 connects to the common connection terminal between the voltage divider resistor R2 and the thermistor R1, and an output terminal OUT of the main processing chip U1 connects to the charging unit 300.

In one embodiment of the present invention, the charging unit 300 includes a charging chip U2, where an input terminal IN of the charging chip U2 connects to the charging power supply 400, a control terminal Ctrl of the charging chip U2 connects to the output terminal OUT of the main processing chip U1, and an output terminal OUT of the charging chip U2 connects to the product 500 being charged.

In one embodiment of the present invention, the thermistor R1 is located on a board in a superheated area of the charger's housing or a board in a superheated area of a housing of the product 500 being charged.

An operating principle of a charging circuit is as follows:

First, a thermistor R1 is installed on a board in a superheated area of a charger's housing or on a board in a superheated area of a housing of a product being charged, where the thermistor R1 is configured to detect a temperature of the charger or a product 500 being charged; power is supplied to the thermistor R1 via a voltage divider resistor R2 and by using a power supply terminal of a PMU or the charger to form a temperature detection circuit. A main processing chip U1 obtains temperature detection information detected by the thermistor R1 by using a detection terminal ADC, the main processing chip U1 sets a temperature upper limit and a temperature lower limit in advance by using software, and compares the temperature detection information with the preset temperature upper limit and the preset temperature lower limit; when the temperature of the product 500 being charged or the charger reaches the temperature upper limit, the main processing chip U1 outputs a control signal from an output terminal OUT, and controls a charging chip U2 so as to reduce a charging current for the product 500 being charged, thereby reducing heat consumption during charging and achieving an objective of reducing the temperature of the charger or the product 500 being charged.

With adjustment of the charging current, when the temperature of the product 500 being charged or the charger reaches the temperature lower limit, the main processing chip U1 controls the charging chip U2 so as to increase the charging current, thereby quickening a charging speed. In this way, a cyclic control may achieve an objective of both ensuring a charging speed and improving thermal experience of a user (or thermal safety of the product).

In the embodiments of the present invention, a charging circuit with heat protection adjusts a magnitude of a charging current according to a temperature of a product being charged or a charger, and then controls the temperature of the product being charged or the charger, thereby greatly improving user experience, and enhancing safety performance of the product with the heat protection function.

The foregoing descriptions are merely exemplary embodiments of the present invention, but are not intended to limit the present invention. Any modification, equivalent replacement, or improvement made without departing from the spirit and principle of the present invention should fall within the protection scope of the present invention.

What is claimed is:

1. A charging circuit comprising:
a temperature detection unit configured to detect a temperature of a product being charged or a charger and generate temperature detection information;
a charging unit disposed between a charging power supply and the product being charged, and configured to provide a charging current for the product being charged; and
a control unit separately connected to the temperature detection unit and the charging unit,
wherein the control unit is configured to:
separately compare the temperature detection information with a preset temperature upper limit and a preset temperature lower limit;
control the charging unit to reduce the charging current when the temperature of the product being charged or the charger reaches the temperature upper limit; and
control the charging unit to increase the charging current when the temperature of the product being charged or the charger reaches the temperature lower limit.

2. The charging circuit according to claim 1, wherein the temperature detection unit comprises a thermistor and a voltage divider resistor, wherein a first terminal of the voltage divider resistor connects to a power supply, wherein a second terminal of the voltage divider resistor is grounded by using the thermistor, and wherein a common connection terminal between the voltage divider resistor and the thermistor connects to the control unit.

3. The charging circuit according to claim 2, wherein the control unit comprises a main processing chip, wherein a detection terminal of the main processing chip connects to the common connection terminal between the voltage divider resistor and the thermistor, and wherein an output terminal of the main processing chip connects to the charging unit.

4. The charging circuit according to claim 3, wherein the charging unit comprises a charging chip, wherein an input terminal of the charging chip connects to the charging power supply, wherein a control terminal of the charging chip connects to the output terminal of the main processing chip, and wherein an output terminal of the charging chip connects to the product being charged.

5. The charging circuit according to claim 2, wherein the thermistor is located on a board in a superheated area of the charger's housing.

6. The charging circuit according to claim 2, wherein the thermistor is located on a board in a superheated area of a housing of the product being charged.

7. A charger comprising:
a charging circuit,
wherein the charging circuit comprises:
a temperature detection unit configured to detect a temperature of a product being charged or the charger and generate temperature detection information;
a charging unit disposed between a charging power supply and the product being charged, and configured to provide a charging current for the product being charged; and
a control unit separately connected to the temperature detection unit and the charging unit,
wherein the control unit is configured to:
separately compare the temperature detection information with a preset temperature upper limit and a preset temperature lower limit;
control the charging unit to reduce the charging current when the temperature of the product being charged or the charger reaches the temperature upper limit; and
control the charging unit to increase the charging current when the temperature of the product being charged or the charger reaches the temperature lower limit.

8. The charger according to claim 7, wherein the temperature detection unit comprises a thermistor and a voltage divider resistor, wherein a first terminal of the voltage divider resistor connects to a power supply, wherein a second terminal of the voltage divider resistor is grounded by using the thermistor, and wherein a common connection terminal between the voltage divider resistor and the thermistor connects to the control unit.

9. The charger according to claim 8, wherein the control unit comprises a main processing chip, wherein a detection terminal of the main processing chip connects to the common connection terminal between the voltage divider resistor and the thermistor, and wherein an output terminal of the main processing chip connects to the charging unit.

10. The charger according to claim 9, wherein the charging unit comprises a charging chip, wherein an input terminal of the charging chip connects to the charging power supply, wherein a control terminal of the charging chip connects to the output terminal of the main processing chip, and wherein an output terminal of the charging chip connects to the product being charged.

11. The charger according to claim 8, wherein the thermistor is located on a board in a superheated area of the charger's housing.

12. The charger according to claim 11, wherein the thermistor is located on a board in a superheated area of a housing of the product being charged.
